(19) United States
(12) Patent Application Publication
(10) Pub. No.: US 2001/0019110 A1
(43) Pub. Date: Sep. 6, 2001

(54) Dosimeter for sun radiation

(76) Inventors: Ori Faran, Haifa (IL); Ezra Natan, Haifa (IL); Dmitry Lastochkin, Nesher (IL)

Correspondence Address: BLANK ROME COMISKY & MCCAULEY, LLP, The Farragut Building, Suite 1000, 900 17th Street, NW, Washington, DC, 20006, US

(21) Appl. No.: 09/729,828

(22) Filed: Dec. 6, 2000

Related U.S. Application Data
(63) Continuation-in-part of application No. 09/140,531, filed on Aug. 26, 1998, now abandoned.
(60) Provisional application No. 60/059,041, filed on Sep. 16, 1997.

(51) Int. Cl. G01J 5/48

(52) U.S. Cl. 250/474.1; 436/58

(57) ABSTRACT

A reusable dosimeter for sun radiation comprising a matrix with at least one active chemical compound distributed therein, capable of reversibly changing its original color to a new color due to a chemical reaction induced by exposure to UV radiation, said matrix made of a material having transparency sufficient for visual detection the change of the original compound's color to the new color, said active chemical compound being capable of changing its color after exposure to UV radiation with an efficacy corresponding to at least 1 MED, and reverting back to its original color after being kept in the dark for about 6 hours.

This is a c-i-p application of pending application Ser. No. 09/140,531 filed Aug. 26, 1998, which in turn is based on and claims priority of applicants' Provisional application Ser. No. 60/059,041 filed Sep. 16, 1997, the subject matter of both being incorporated herein by reference. This application also claims priority of application Ser. No. 09/089,252 filed Jun. 3, 1998, now U.S. Pat. No. 6,132,682, issued on Oct. 17, 2000 to the assignee of the present application. The subject matter of U.S. Patent No. 6,132,682 is incorporated herein by reference.

### FIELD OF THE INVENTION

The present invention refers to an ultraviolet radiation dosimeter.

The ultraviolet region (UV region) is a region of the electromagnetic spectrum adjacent to the low end of the visible spectrum. The UV region extends between 400-100 nm, and is divided into 3 sub regions: the UVA region (400-320 nm), the

UVB region (320-280 nm), and the UVC region (280-100 nm). Of the three regions, the exposing to radiation in the UVB region is considered to be the most dangerous to human beings, since it causes several types of the most common cancer in human beings, i.e. skin cancer. One of the types of this cancer, namely melanoma, is lethal. In addition to the above, exposure to radiation in the LTVB region can cause skin aging and is also harmful to eyes.

Radiation in the UVA region mainly causes damage, such as photo-aging, to the skin. Radiation in the UVC region does not penetrate the ozone layer, which fortunately also blocks most of the radiation in the UVB and the UVA region.

In the last two decades the levels of UV radiation that reach the earth, have increased substantially due to the depletion of the ozone layer, caused by the release of various chemicals in the form of aerosols into the atmosphere.

In some parts of the world the level of UV radiation has increased by 30-50%. The consequence of this process is a substantial increase, in the danger of exposure to the sun's radiation.

It is believed, for example, that every 1% increase in the level of UV radiation, corresponds to a 4% increase in the number of skin cancer cases. Indeed, according to medical statistics the number of skin cancer cases has increased by hundreds of percents in the last 20 years.

UV radiation induces biological effects depending on the particular wavelength of the radiation. It is known to evaluate total biological or hazard weighted irradiation by multiplying the spectral irradiation at each wavelength by the biological or hazard weighted factor and then summation results of the multiplying over all. the wavelengths.

Biological or hazard factors are obtained from the so-called action spectrum according to Environmental health criteria 160 “Ultraviolet radiation” issued by the World Health Organization, Geneva, 1994. An action sp ectrum is a graph of the reciprocal of the radiant exposure required to produce the given harmful effect at each wavelength. All the data in such graphs are normalized to the datum at the most efficacious wavelength. By summation of the biologically effective irradiation over the exposure period, the biologically effective radiant exposure (efficacy in J/m²) can be calculated.

The action spectrum graph for LTV induced erythema was adopted worldwide by many organizations such as:

1. ACGIH (American Conference of Governmental Industrial Hygienists)

2. WHO (World Health Organization)

3. UNEP (United Nations Environment Program)

4. INIRC (International Non Ionizing Radiation Committee)

The action spectrum graph is a complex curve, obtained by statistical analysis of many research results establishing the minimum radiant exposure to the UV radiation at different wave lengths sufficient for causing erythema.

The most commonly used quantity of radiation associated with the erythernal potential due to exposure to UV radiation is the number of so-called minimum erythernal doses (MED) caused by the exposure. An MED is defined as the radiant exposure of the UV radiation that produces a just noticeable erythema on previously unexposed skin. The radiant exposure to monochromatic radiation at around 300 nm with the maximum spectral efficacy, which is required for erythema co- fresponds to approximately 200 to 2000 J/m² efficacy, depending on the skin type.

The skin reacts to radiation by changes in the melanin content. Subsequent to the change in the melanin content reddening occurs, and then soreness and signs of sun burning appear.

There exist 5 types of skin types which differ according to the color of human hair, eyes, and skin, and by their reaction to overexposure to UV radiation. The permissible time for exposure to UV radiation on a mid summer day changes from 15 minutes for skin type no. 1, to about 2 hours for skin type no. 5 (without using sun screen).

Most people are not aware of the danger that can arise even after limited exposure to UV radiation, because the dose is accumulated during the exposing for varying periods of time in a daily life routine. The first visible sign is usually sunburn, which might only become visible after a few hours. This means that the individual becomes aware of the danger only after the damage has already been done. It should be emphasized that skin cancer might even appear years later.

Unfortunately, most people routinely do not use sun screens unless they are on the beach or a trip. Even then people usually do not use means of protection before they become exposed to the sun's radiation, and do not repeat applying sunscreen during exposure to the sun.

UV radiation level changes continuously, because of latitude, air pollution, season of year, clouds, and other factors. Therefore, it is very difficult to give accurate, reliable and timely warnings to the public about the LTV radiation levels for specific location and day time. The only practical means that the public can use to defend itself is a personal dosimeter.

There is a known-in-the-art disposable dosimeter for sun radiation as per Shiseido Co.'s U.S. Pat. No. 4,829,187. This dosimeter employs a photo sensitive composition consisting of a discoloring agent, a photo activator and a UV-ray absorber. The photo activator forms free radicals by the irradiation of UV rays and the discoloring agent exhibits a color change in the visible region of a spectrum through the action of free radicals and a UV-ray absorber. The disadvantage of this dosimeter is associated with the fact that its principle of operation, and therefore the compound employed therein, is neither suitable to measure the radiation dose which is equivalent to an NED, nor is it selective to different types of the user's skin. The known dosimeter is designed in such a manner, that the amount of UV-radiation necessary for inducing the color change can be either 1 - 100 J/cm² or 10⁻⁵ J/cm². These values are far away from the magnitude of UV-radiation corresponding to an MED, which is about 20 mJ/cm² for skin type no. 2.

Also known is a method and device for monitoring UV radiation as disclosed in Cybrandian Ltd.'s U.S. Pat. No. 5,117,116. In the specification of this patent it is mentioned that to facilitate quantifying the minimum dose of UV radiation an individual can tolerate, the dose of UV radiation which induces reddening in the skin is referred to as the Minimum Erythernal Dose. This dosimeter employs a chemical compound capable of changing its color on being subjected to UV radiation reflected from the skin of the user. The principal disadvantage of this provision is associated with the fact that various types of skin in various conditions reflect differently and therefore cause enormous uncertainty in the determining of the actual dose of UV radiation to which the skin of an individual has been subjected irrespective of whether this dose is attributed as an MED or not. Furthermore, there is no mention in the specification of the above patent how the outside temperature might influence the performance of the chemical compound. Since for monitoring reflected radiation the dosimeter should be provided with a dedicated support means capable of directing the reflected radiation upon the chemical compound the dosimeter's construction is complicated and inconvenient to use.

There is known a sunburn dosimeter as disclosed in American Cyanamid Co.'s U.S. Pat. No. 3,903,423. The principle of operation of this dosimeter is based on comparing the color change of a test area bearing chemical compounds capable of changing their color depending on the cumulative exposure to UV radiation with a standard area. The standard area bears a chemical compound which changed its color after exposure to different predetermined quantities of sunburn radiation. Unfortunately, the chemical compounds employed in this dosimeter are not chosen depending on their sensibility to a radiation, the amount of which is equal to an MED. These compounds are chosen depending on their capability for coloration after exposure to radiation referred to arbitrary time units and assuming that there exists a linear relationship between the ultimate time of exposure and the skin type. This assumption is not correct from the medical point of view. It should also be mentioned that comparison of a test area with a standard area is inevitably subjective and therefore renders the dosimeter less accurate.

Furthermore, there is known an ultraviolet radiation dosimeter as per Trumble's U.S. Pat. No. 3,787,687. The principle of operation of this dosimeter is similar to the previously mentioned dosimeter and is based on the comparison of a standard color chart with the color of a chemical compound exposed to UV radiation. The chemical compounds employed in this dosimeter are not chosen deliberately depending on their sensitivity to an NED of radiation or to skin type.

None of those dosimeters has the ability to keep its color unchanged after exposure to the sun radiation at temperature up to 50° C., and to revert its color only after it was kept for several hours in darkness.

Thus, it is apparent there is still a need for a new, convenient, accurate and safe dosimeter which is both capable of giving timely and unequivocal warning to the user about the amount of sun radiation to which he has been exposed and which can be used by individuals with different skin types. In medical literature it is known that the so called “repair time” of the human skin is in the order of one day. Therefore the most essential feature of a reversible dosimeter should be its ability to revert to its original color only after it was kept in the darkness for several hours and no more then one night. None of the mentioned above prior art dosimeters have that ability.

### OBJECTS AND SUMMARY OF THE INVENTION

An object of the present invention is to provide for a new and improved dosimeter, which is simple, cheap, convenient and is suitable for daily use by individuals.

Another object of the present invention is to provide a reversible dosimeter employing active photochromic compound which changes its color after exposure to the sun's radiation with the efficacy of at least 1 MED.

Still another object is to provide a reversible dosimeter that advises the user to terminate exposure to the sun's radiation after the whole dosimeter's surface has changed its initial color to another color indicating that the user has been exposed to 1 MED radiation.

Yet, another object of the present invention is to provide a dosimeter which is equally suitable for use by individuals with different types of skin and can be conveniently worn by the user.

Another object of the invention is to provide a dosimeter which in contrast to the known in the art dosimeters does not require a comparison with a reference chart.

Another object of the present invention is to provide for a new and improved reusable dosimeter to alert the user when to terminate the exposure in accordance with his skin type and which is reusable a great number of times without deterioration of the dosimeter's performances. These and other objects and advantages will become apparent from the description which follows.

After comprehensive studies were conducted in connection with the components of the reversible dosimeter based on the concept of stabilization of an active organic compound by a fixing agent, it was unexpectedly found by us that the above requirements are satisfied using a solubilized mixture comprising an active compound and fixing agent, which are incorporated in a host medium. It was also found that different proportions between these two components affect the number of cycles of the new dosimeter.

### BRIEF DESCRIPTION OF THE DRAWINGS

FIG. 1 shows example of an action spectra graph.

FIG. 2 shows the relative intensity of UV solar radiation versus wavelength.

FIG. 3 is a graphic illustration of solar radiation efficacy as a function of time. The graph refers to skin type No. 2 and corresponds to, 1 MED monochromatic radiation with wavelength 297 nm.

FIGS. 4a,b,c,d,e,f show applications of the new dosimeter which can be either worn by a user or attached to various equipment.

FIGS. 5a-5e show various cross-sections of the dosimeter in accordance with various embodiments thereof

FIGS. 6a-6c schematically show the dynamic output (change of color) of the dosimeter as function of the increasing radiation dose received by the dosimeter.

FIG. 7 shows the reaction of photochemical dissociation of the carbonyl.

FIG. 8 shows the chemical formula of viologens.

FIG. 9 shows the chemical reaction responsible for change of color which is governed by the electron transfer.

FIG. 10 shows the chemical formula of spiropyrans and spirooxazines suitable for use in the present invention.

FIG. 11 shows the chemical reaction governed by the ion mechanism responsible for change of color in spiropyrans, and spirooxazines.

FIG. 12 shows the chemical formula of bisimidazole derivatives suitable for use in the present invention.

FIG. 13 shows the chemical reaction governed by the mechanism of radical dissociation.

### DETAILED DESCRIPTION OF THE PREFERRED EMBODIMENTS

Since the device in accordance with the present invention functions as a dosimeter and not as a detector, it is very important that it be attached to the user's clothing or equipment in such a manner that it absorbs the same amount of sun radiation as that to which the user is exposed.

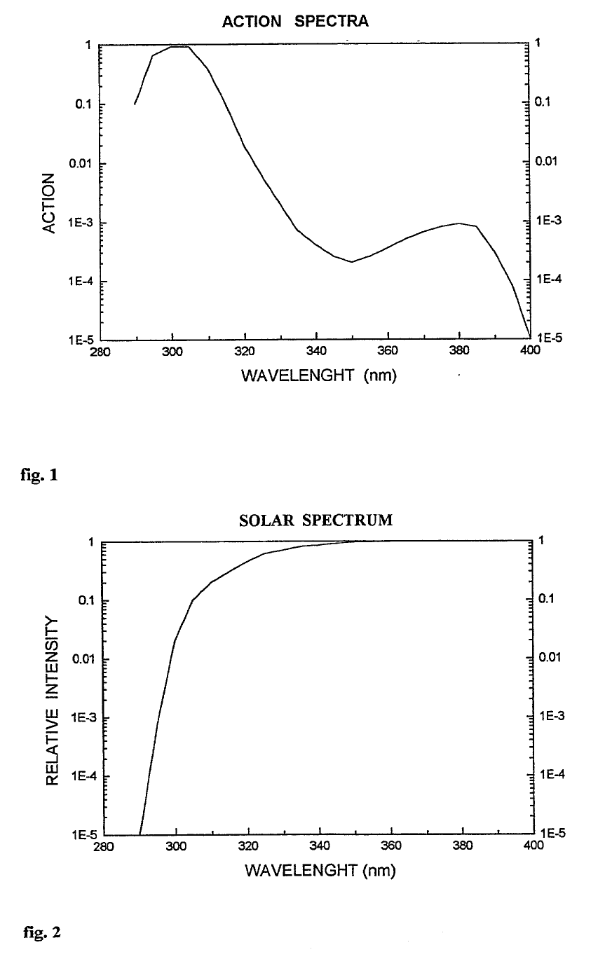

The specific photochromic substances employed in the dosimeter of the present invention are selected in such a manner that they are sensitive to exposure to solar radiation in the UV region, but not necessarily at the wavelengths which corresponds to the peak of action spectrum as shown in FIG. 1, because this wavelength band (around 300 nm) is beyond the visible spectrum in which it is desirable that the color change takes place.

On the other hand the desirable wavelength band in which the photochromic compound changes its color should not be too far from the wavelength corresponding to the action spectrum peak. This is required in order to eliminate possible mistakes associated with the extrapolation from the wavelength at which a particular photochromic compound changes its color to the wavelength corresponding to the action spectrum peak.

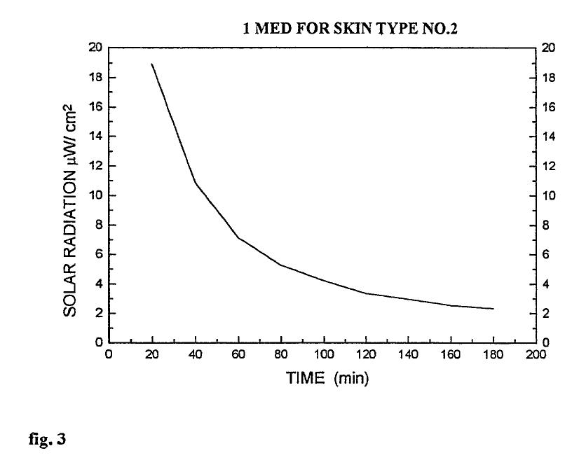

The amount of UV radiation that can present a danger to an individual exposed to the sun's radiation is determined on the basis of existing action spectra and available data for each skin type. An average integral of the intensity of radiation vs. time is calculated from the MED efficacy-time dependence available for monochromatic radiation of 297 rim. An example of this dependency referring to skin type No. 2 is shown in FIG. 3.

The effective intensity of irradiation at a particular wavelength or band, to which the employed photochromic compound is sensitive is determined from the dependence of UV radiation intensity vs. wavelength., The example of this function is shown in FIG. 2. This intensity is then extrapolated to the intensity of an irradiation taking place at 297 mn and at the conditions to which the user will be exposed.

In laboratory conditions the color change of the dosimeter can be induced by exposing the dosimeter to a radiation dose produced by a sun simulator (type 16S, manufactured by Solar Light Co.), capable of emitting up to 20 times the sun radiation intensity in the UV region.

The simulator is provided with a radiation dose control means that allows to set the radiation in J/m² to the desired dose in MED. For this purpose individual samples of photochronfic compounds are distributed on the surface of 1 square cm and subjected to high intensity radiation so as to induce change of color. Afterwards the samples are subjected to the sun's radiation. The reversibility of color and the influence of ambient temperature are tested both in the UV region and in full spectrum of the sun's radiation.

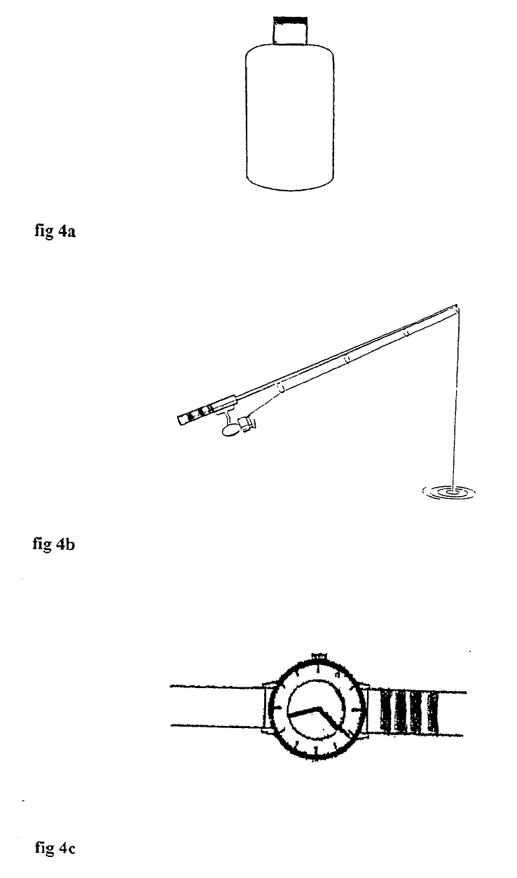

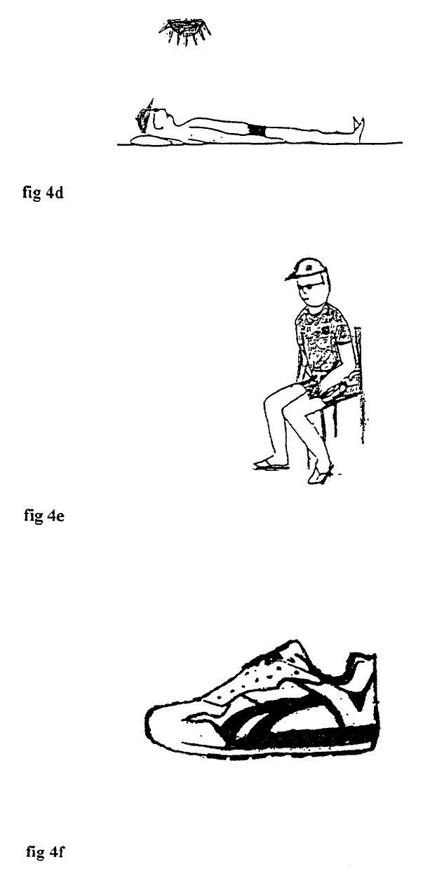

With reference to FIGS. 4a,b,c,d,e,f, it is shown how the new reversible dosimeter, can be worn by a user as a sole independent item, i.e. bracelet, watch strap or medallion, or applied to a clothing, hat, footwear, equipment etc. as a garment, symbol or the like.

In accordance with one aspect of the present invention, the dosimeter comprises an active chemical compound which undergoes photo-chemical reaction accompanied by changing of its color, and an absorber. Both the chemical compound and the absorber are distributed within a polymeric matrix. The particular combination of an active chemical compound, absorber and matrix material is chosen in such a manner that the dosimeter changes color during exposure to solar radiation, the efficacy of which exceeded the individual's permissible MED corresponding to his personal skin type. Provided in accordance with the invention are up to 5 types of dosimeters which can be combined, each of them capable of responding to solar radiation dose, which is corresponding to 1 MED required for a particular skin type. By virtue of this provision the user can avoid damage to his skin and/or his eyes.

Since the new dosimeter operates continuously irrespective of whether it is exposed either to direct or reflected sun radiation it can be appreciated that the dosimeter does not affect the user's daily activities. By virtue of this provision the public's attitude to use such a dosimeter will be more positive and thus there will also be increased awareness of the danger of exposure to UV radiation.

The user can also use the dosimeter simultaneously with a sun screen by applying it to the dosimeter surface, and thus increase the permissible time of exposure to the sun's radiation.

With reference to FIGS. 5a-e the construction of the dosimeter will now be explained. The dosimeter comprises a polymeric matrix 2. The aim of the matrix is to carry an active chemical compound therein, to reliably protect it from corrosion due to ambient humidity and to impart thereto machinability. The matrix material should be thermally stable, i.e., should not alter its opaqueness after heating up to 50° C. so as to retain its transparency sufficient for visualizing the variation of color of an active compound incorporated in the matrix. As an example of a suitable matrix material one can use various optically transparent materials, for example, polycarbonates, polystyrenes, polyolefines, polyacrylates such as polymethylmethacrylates, polyvinyl derivatives, polyester derivatives, polyvinyl chloride; cellulose derivatives such as cellulose acetate, polyurethanes, polyethylene terephthalate; silicone resins such as LSR (liquid silicone rubber), triethylene glycole dimethacrylate (TEGDM, commercially known as CR-39), epoxys etc. Transparent copolymers and blends of dissimilar transparent polymers are also suitable as a matrix material.

FIG. 5a shows the matrix within an active photochromic compound 4 distributed therein. It might be recommended to attach to the matrix a thin filter film F so as to prevent undesirable color changes induced by irradiation with wavelengths corresponding to another part of electromagnetic spectrum and thus to control the dynamics of color change. Instead of attaching the filter film the matrix may contain an UV absorbing material 6 distributed therein. The principle of choosing of the active compound in accordance with the present invention will be explained further. The UV absorber consists of a material that is capable of partially absorbing the LTV radiation.

By virtue of this provision it becomes possible to control the amount of accumulated radiation to which the active compound is exposed. Examples of materials suitable for use as absorbers include:

2,4-bis(2,4-dimethylphenyl)-6-(2-hydroxy-4-n-octyl-oxyphenyl)-1,3,5-triazine.

2-hydroxy-4-(N-octoxy)benzophenone.

2-(2-hydroxy-5-methyl-phenyl)-2H-benzotriazole.

2-(2H-benzotriazol-2-YL)-4,6-ditertpentylphenol.

2,2′-dihydroxy-4,4′-methoxybenzophenone.

2,2′,4,4′-tetrahydroxybenzophenone.

2,2′-dihydroxy-4,4′-dimethoxybenzophenone.

In practice the total thickness of the matrix layer lies between 0.25-2.5 mm.

The active compound and absorbing material can be incorporated within the matrix by means of any known-in-the-art suitable method, for example by compounding or casting. The dosimeters can be manufactured by any known-in-the-art suitable method, for example by injection molding or extrusion. In practice the amount of an active compound or absorbing material within the matrix varies between 0.1 to 10 weight percent depending on the matrix material, type of an active compound and particular type of the user's skin.

FIG. 5b shows an embodiment of the present invention in which the active compound and absorbing material are substantially homogeneously distributed within the matrix.

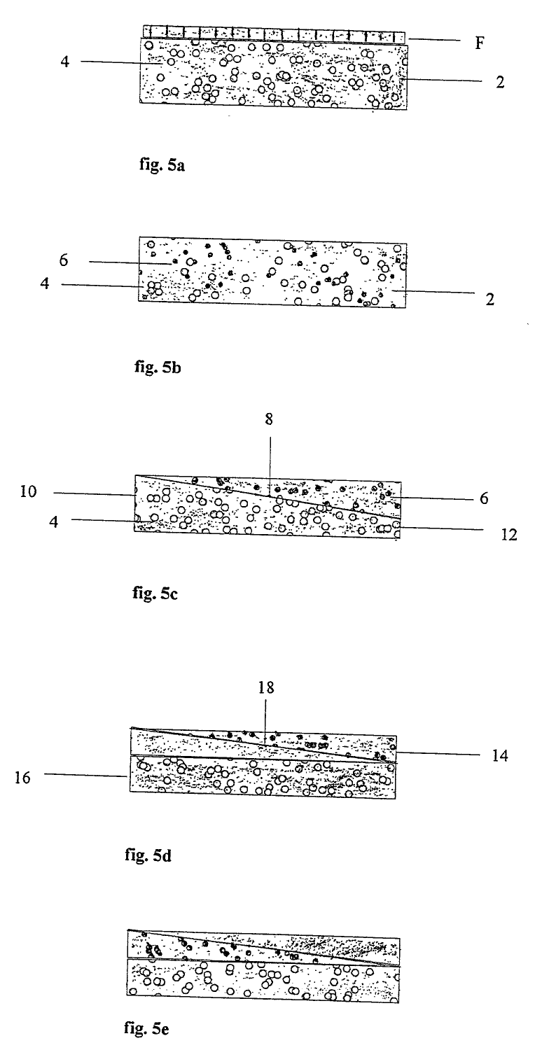

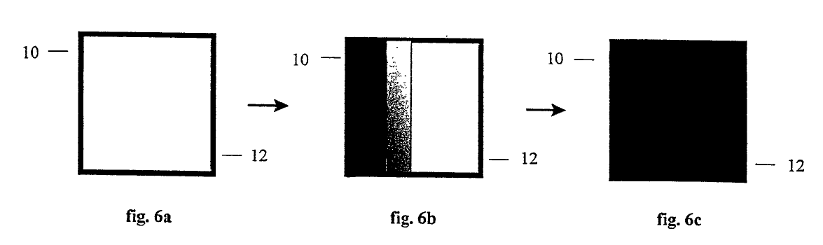

FIG. 5c shows an alternative embodiment of the dosimeter in which the active compound is distributed in one part of the matrix, while the absorbing material is distributed in the other part thereof and there is provided a border line 8 separating there-between. The direction and slope of this border line is deliberately chosen so as to create a gradient of thickness of the layer containing the absorber, i.e. a minimum thickness thereof at one lateral side 10 of the dosimeter, which gradually increases to a maximum thickness thereof at the opposite lateral side 12 of the dosimeter. It can be appreciated that the effective concentration of the active compound also varies along the same border line from being correspondingly at its maximum at the side 10 and at its minimum at the opposite side 12. By virtue of this provision it is possible to control the amount of radiation accumulated by the active compound residing in different locations within the matrix and thus to achieve dynamic response of the active compound to the radiation dose the user has been exposed to. Referring now to FIGS. 6a-c it can be seen that by virtue of the gradient of absorber concentration, the coloration of the active compounds takes place not simultaneously over the whole surface of the dosimeter, but initiates at the side 10 and then gradually expands towards the opposite side 12 as shown in FIG. 6b until the entire surface of the dosimeter changes its color as shown in FIG. 6c. It can be advantageous to add to the polymeric matrix a dye or an organic pigment in order to impart suitable initial color to the dosimeter surface which could strengthen the contrast with the color of the active material after it has been exposed to the UV radiation. The classes of the organic pigments suitable for this purpose comprise Phtalocyanine, Quinacridone, Isoindolinone, Perylene, Anthraquinone, etc.

It can readily be appreciated that by the variation of thickness of the layer containing the UV absorbing material it is possible to render the dosimeter employing the same active compound suitable for users having different skin types.

FIGS. 5d-e show two additional embodiments of the dosimeter in which the thickness of the absorber containing layer varies.

In FIG. 5d the active compound is distributed in the lower portion 16 of the matrix and its concentration is homogeneous. Within the upper portion 14 of the matrix is distributed the absorbing material and there is deliberately created a gradient of 30 thickness of this portion and thus of the effective concentration of the absorber along a border line 18. One can see that at the left side of dosimeter the active compound is separated from the upper surface exposed to UV radiation only by the transparent matrix, while at the opposite side it is separated from this surface by the matrix with the absorber distributed therein. The lower and upper layers of the matrix can be made of similar or dissimilar material and thus, one can provide even better control of the dynamic response of the active compound to the UV radiation.

FIG. 5e shows the embodiment similar to that shown in FIG. 5c while the gradient-of thickness of the absorber containing matrix is arranged in such a manner that at the left side of the dosimeter the active compound is separated from the upper surface by the matrix with absorber and at the opposite side the active compound is separated from the upper surface solely by the matrix.

Having explained the construction of the new dosimeter it will now be explained in more detail how the chemical compounds employed therein are chosen. It has been empirically established that those photochromic compounds which satisfy the following criteria can be advantageously employed in the dosimeter according to the present invention:

1. The active compound should be capable of undergoing photochemical reactions accompanied by coloration in response to cumulative UV radiation of which the efficacy corresponds to at least 1 MED. The photochemical reaction should be accompanied by relatively slow change of the compound's color during at least 15 min (for skin type No. 1) and no longer than during several hours (for skin type No. 5).

2. The compound should not change or reverse its color after it has been exposed to the sun radiation for at least 8 hours at a temperature up to 50° C.

3. The reverse reaction should take place after the dosimeter has been kept for several hours in darkness (and no more then one night). The number of coloration/discoloration cycles without significant fatigue should be between 10 to 300 depending on the particular application of the dosimeter.

4. The mechanism of photochemical reaction responsible for coloration of the active compound should be at least one mechanism chosen from the group including photochemical dissociation of carbonyl group, electron transfer, formation of ions, and radical dissociation.

Some non-exhaustive representative examples of active photochromic compounds which satisfy the above criteria are listed below:

a) Chromium hexacarbonyl for example as described in Massey, A. G.; Orgel, L. E. Nature, 4796, 1387 (1961). Presented with reference to FIG. 7, the reaction of photochemical dissociation of the carbonyl, responsable of the change of color.

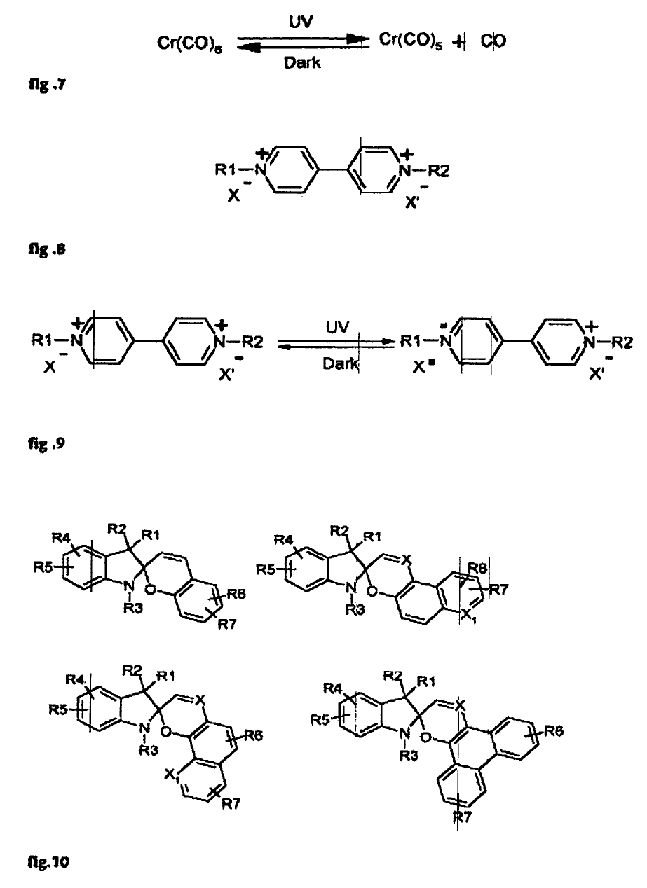

b) Viologens derivatives, as described for example in Kamogawa, H; Mizuno, H., J. Polym. Sci., 17, 3149 (1979). This class of compound is represented by the general formula shown in FIG. 8 in which R₁ and R₂ represent an alkyl group, an aromatic group or a carboalkoxy group and X a Halogen. The chemical reaction governed by the 5 electron transfert is presented with reference to FIG. 9.

c) Spiropyrans (X═C) and Spirooxazines (X═N) derivatives are represented by the general formula shown in FIG. 10. In the above formula R₁, R₂, R₃, R₄, R₅, R₆, R₇ represent independently an alkyl group, an aromatic group, an alkoxy group, a nitro group or a halogen X, can represent the group CH or the heteroatom N. For example as described in Berman, E.; Fox, R., J. Am. Chem. Soc., 815605 (1959). The chemical reaction governed by the formation of ions is presented with reference to FIG. 11.

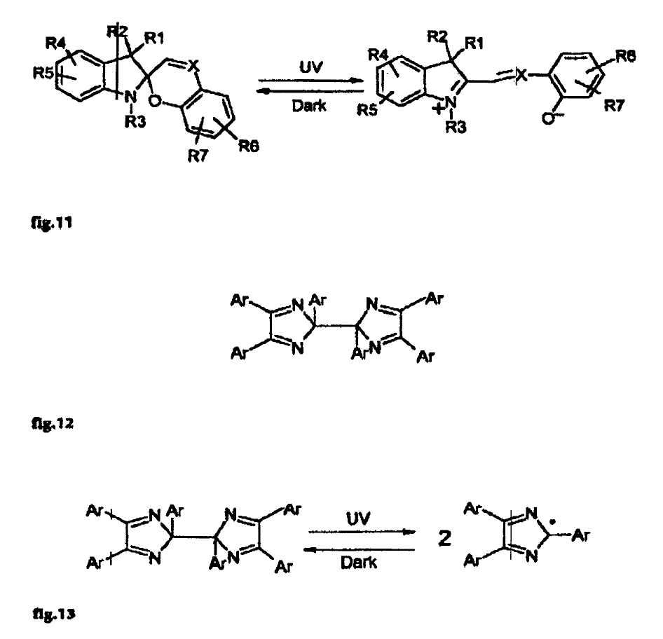

d) Bisimidazoles derivatives for example as described in White, D. M.; Sonnenberg, J., J. Org. Chem., 29, 1926 (1964). This group of compounds is represented by the general formula shown in FIG. 12. In the above formula R represents a phenyl group, a methylphenyl group, a methoxy phenyl group or Halogen phenyl group. Presented with reference to FIG. 13, the mechanism of radical dissociation.

The present invention will now be disclosed with reference to non-limiting examples presented hereinafter.

Example No. 1

The dosimeter is designed for skin type No. 2 and has total thickness of 1 nun. The matrix is manufactured in the form of a film by casting from the polymer solution. The lower layer of the matrix is made of PMMA and has thickness 0.5 mm. Distributed within the layer is 4 weight percent of an active photochromic material, which is Chromium-hexacarbonyl. The upper layer has thickness 0.5 mm, made of PMMA.

Distributed within this upper layer is 1 weight percent of a UV absorber, which is 2-(2hydroxy-5-methyl-phenyl)-2H-benzotriazole. The dosimeter in this example refers to an embodiment shown in FIG. 5c with an upper layer having gradient of thickness. The upper layer is cast separately and then attached to the matrix. The dosimeter changes its color from transparent to yellow after irradiation of 1 MED (skin type 2). The dosimeter was irradiated by the sun during different day hours and during different seasons. The tests were calibrated by a PMA2100 data logger with a PMA2101 and PMA2102 UVB detectors manufactured by the Solar Light Co. The dosimeter's color is not influenced neither after being held in the sun or light without time limitation, or being held in darkness for at least 5-6 hours, nor at the temperature 50° C. This dosimeter reverts its color 200 times without significant fatigue.

Example No. 2

The dosimeter is designed for skin type No. 2′ and comprises a matrix made of polystyrene. The total thickness of the dosimeter is 1.5 mm. The matrix in the form of a film is cast from the polymer solution. The lower layer of the matrix has a thickness of 1 mm and contains 3 weight percent of an active compound which is 2,2′,4,4′,5,5′-hexa-p-Chlorophenyl-bis-imidazole. The upper layer has a thickness of 0.5 mm and distributed therein is 1.5 weight percent of a LTV absorber, which is 2,2′-dihydroxy-4,4′-methoxybenzophenone. The dosimeter according to this example refers to an embodiment shown in FIG. 5c with an upper layer having a gradient of thickness. The upper layer is cast separately and then attached to the matrix. The dosimeter changes color from transparent to purple after irradiation of 1 MED (of skin type no. 2).

The dosimeter was irradiated by the sun during different hours of the day and during different seasons. The tests were calibrated by a PMA2100 data logger with a PMA2101 UVB detector manufactured by Solar Light Co. The dosimeter's color is not influenced neither after being held in the sun or light without time limitation or being held in darkness for at least 6 hours, nor at the temperature 50° C. This dosimeter reverts its color 50 times without significant fatigue.

Example No. 3

The dosimeter is designed for skin type No. 3 and has the total thickness 0.5 mm. The matrix in the form of a film is cast from the polymer solution. The lower layer of the matrix is made of PVA and contains 2 weight percent of an active compound which is N-Benzyl-N′-n-Propyl-4,4′-Bipyridinium dichloride. The upper layer with an absorber therein is made of PNBIA. It has a maximum thickness of 0.25 mm and distributed therein is 0.25 weight percent of an UV absorber, 2-(2-hydroxy-5-me thyl-phenyl)-2H-benzotriazole,. The dosimeter according to this example refers to an embodiment shown in FIG. 5b with an upper layer having a gradient of thickness. This layer is cast separately and then is attached to the matrix. The dosimeter changes its color from transparent to blue after irradiation of 1 MED.

The dosimeter was irradiated by the sun during different hours of the day and during different seasons. The tests were calibrated by a PMA2100 data logger with a PMA2101 UVB detector manufactured by the Solar Light Co. The dosimeter's color is not influenced neither after being held in the sun or light without time limitation, nor being held in darkness for at least 6 hours, nor at the temperature 50° C. This dosimeter reverts its color 10 times without significant fatigue.

It should be appreciated that the present invention is not limited to the above-described embodiments and that changes and modifications can be made by one ordinarily skilled in the art without deviation from the scope of the invention, as will be defined in the appended claims.

The dosimeter of the present invention can be used for measuring the UV dose to which not only people but also to which other objects were exposed, for example, plants or animals in agriculture, various sensible equipment to be exploited at the conditions of exposure to LTV radiation, etc.

Best Mode

In accordance with the present invention, additional embodiments of the dosimeter comprise:

an active chemical compound which undergo reversible photo-chemical reaction accompanied by changing its color and

a fixing, substantially inorganic agent capable to inhibit the above reversible reaction and thus to enable the active chemical compound to gradually change its initial color after the dosimeter has accumulated the amount of UV radiation, which efficacy corresponds to the skin type of the user and then to revert to its original color after being kept in the dark from about 8-10 hours.

optional suitable functional additive(s), e.g. an UV absorbing agent, pigment, etc.

The above constituents, i.e. active chemical compound, fixing agent and optional functional additive(s) are distributed within a polymeric matrix, The particular active chemical compound, fixing agent and the additive(s) are selected in such a manner that the dosimeter changes its color during the exposure to solar radiation with efficacy corresponding the individual's personal permissible MED corresponding to his personal skin type and reverts to its original color after being in the darkness for up to 10 hours. By virtue of this provision the dosimeter can be used again on the next day.

Non limiting list of active chemical compounds suitable for use in the preferred dosimeter of the present formulation comprise: a) Spirobenzopyrans derivatives, shown below (I):

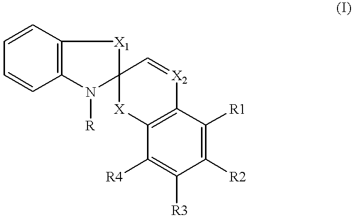

wherein: X=0 or S; X₁=0, S or CR′R″ where R′ and R″ are independently, hydrogen, an alkyl group, halogen or only a single group, e.g., substituted alkyl chain; X₂=N or CH; and R,R₁,R₂, R₃, R₄, represent independently, hydrogen, an alkyl group, a functionalized group, an alkoxy group, a nitro group or a halogen. R₁,−R₂,_R₂,−R₃,−R₃−R₄ can also represent independently a single group, e.g., a substituted alkyl chain or a substituted aromatic group.

b) spiropyranopyrans derivatives, shown below (II):

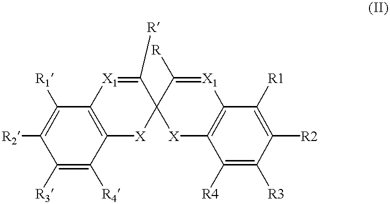

wherein: X=0 or S: X₁=N or CR₅; and R, R₁, R₂, R₃, R₄, R₅, R′, R₁,R₂′, R₃′,R₄′ represent independently, hydrogen, an alkyl group, a functionalized group, an alkoxy group, a nitro group or a halogen. R₁−R₂, R₂−R₃,R₃−R₄, R₁′−R₂′, R₂′−R₃′, R₃′−R₄′ can also represent independently a single group, e.g., a substituted alkyl chain or a substituted aromatic group.

c) Spiroquinolinopyrans derivatives, shown below (III):

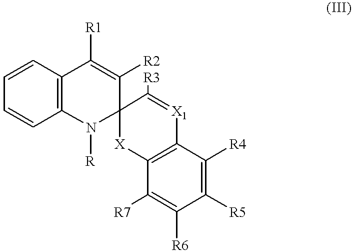

wherein: X═O or S; X═N or CR′; and R′, R, R₁, R₂, R₃, R₄, R₅, R₆, R₇ represent independently, hydrogen, an alkyl group, a functionalized group, an alkoxy group, a nitro group or a halogen. R₄−R₅, R₅−R₆, R₆−R₇ can also represent independently a single group, e.g., a substituted alkyl chain or a substituted aromatic group.

d) Naphthopyrans derivatives, shown below (IV):

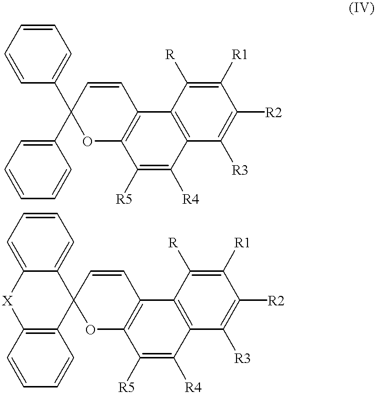

wherein: X═O, S, N—R′ where R′ is an alkyl group or a functionalized group, (CH₂)ₙ where n=0, 1 and R, R₁, R₂, R₃, R₄, R₅ represent independently, hydrogen an alkyl group, a functionalized group, an alkoxy group, a nitro group or halogen. R−R₁, R₁−R₂, R₂−R₃,R₃−R₄,R₄−R₅ can also represent independently a single group, e.g., a substituted alkyl chain or a substituted aromatic group.

The above mentioned compounds may be used separately or in combination of at least two of them. The amount of the active chemical compound employed preferably ranges from about 0.1% -0.3% by weight based on the whole formulation.

Non limiting list of suitable fixing inorganic agents includes: Copper acetate, copper acetate monohydrate, copper bromide, copper chloride, copper perchlorate hexahydrate, nickel acetate tetrahydrate, nickel bromide, nickel chloride, nickel perchlorate hexahydrate, manganese acetate dihydrate, manganese bromide, manganese chloride, manganese perchlorate hexahydrate, magnesium acetate tetrahydrate, magnesium bromide, magnesium chloride, magnesium perchlorate hexahydrate, zinc acetate, zinc bromide, zinc chloride, zinc iodide, zinc perchlorate hexahydrate, zinc p-toluenesulfonate hydrate, iron acetate, iron bromide, iron chloride, iron perchlorate hexahydrate, ytterbium acetate tetrahydrate, ytterbium bromide, ytterbium chloride, ytterbium perchlorate, cesium chloride, gallium chloride, barium perchlorate, and any other suitable inorganic compound, capable of reacting in a Lewis acid-base reaction,

The above listed fixing agents could be used separately or in any combination of at least two of them, The amount of the fixing agent employed in the formulation of the dosimeter is preferably about 0.05% - 0.5% by weight based on the whole composition.

The mixture of the above constituents is incorporated in a polymer matrix made of appropriate optically transparent or half opaque plastic materials. Non limiting list of suitable plastic materials comprises polycarbonates, polystyrenes, polyolefins, polyacrylates such as polymethylmethacrylates, polyvinyl derivatives, polyester derivatives, polyvinyl chloride; cellulose derivatives, such as, cellulose acetate, polyurethanes, polyethylene terephthalate, silicone resins such as LSR (liquid silicone rubber), triethylene glycole dimethacrylate (TEGDM, commercially known as CR39). epoxy resins. The matrix composition may also include plastisizers, e.g. phthalic acid esters, phosphoric esters., adipic acid derivatives, camphor, etc., taken alone or in any combination. Transparent copolymers and blends of dissimilar transparent polymers are also suitable as material for host matrix. The preferred manufacturing methods for manufacturing of the dosimeter from the plastic matrix, containing active compound and fixing agent are injection molding (including co-injection in the case of more complicated articles), and extruding.

As already mentioned, the composition of the dosimeter of the present invention may also contain various functional additives. Non limiting list of suitable functional additives comprises dyes, pigments, ultraviolet absorbers, antioxidants, reduction preventing agents, reducing agents, chelating agents, etc.

The present invention will now be disclosed with reference to non-limiting examples 4-6 below. In the following examples, the efficacy of the UV radiation refers to the MED of skin type No.2.

Example No. 4

A dosimeter for skin type No. 2 was cast by extrusion to obtain thin film with thickness 0.4 mm. The dosimeter comprised polypropylene matrix containing all necessary components.

The composition of the matrix comprised:

2 g active chemical compound, namely, 1′.3′-Dihydro-1′,3′,3′-trimethyl-6-nitrospiro[2H-1-benzopyran-2-2′-(,2H)-indole];

1 g fixing agent, namely, nickel perchlorate hexahydrate.

1.5 g masterbatch of red color pigment L-541 8, manufactured by Kafrit Ltd., Israel;

10 g Tinuvin P manufactured by Ciba-Gaigy Ltd.,Switzerland; and

1000 g polypropylene.

The dosimeter was exposed to sun radiation with an average intensity of 2 MED/Hour to accumulate UV radiation with efficacy 1 MED. The exposure took place during different seasons and during different daytime. For calibration of the dosimeter was used digital dosimeter PMA2100 with detector PMA2101 UVB manufactured by Solar Light Co.

The dosimeter when exposed to the sun changed its color from red to blue during 0.5 hour and then returned to the original red color after staying 9 hours in the dark.

This process was repeated 14 days without significant deterioration of the dosimeter's performances.

Example No. 5

A dosimeter for skin type No. 3 was cast by extrusion to obtain thin film with thickness 0.4 mm. The dosimeter comprised polypropylene matrix containing all necessary components.

The composition of the matrix comprised:

1 g active chemical compound, namely, 1′,3′-Dihydro-1′,3′,3′.trimethyl-6-nitrospiro[2H-1-benzopyran-2-2′-(2H)-indole].

0.5 g fixing agent, namely, iron perchlorate hexahydrate;

2 g masterbatch of yellow color pigment L 3493, manufactured by Kafrit Ltd., Israel;

7 g Cyasorb UV-1164 manufactured by Cytec industries Inc., U.S.A.; and

1000 g polypropylene.

The dosimeter was exposed to sun radiation with an average intensity of 2 MED/Hour to accumulate UV radiation with efficacy 1.5 MED. The exposure took place during different seasons and during different daytime. For calibration of the dosimeter was used digital dosimeter PMA2100 with detector PMA2101 UVB manufactured by Solar Light Co.

The dosimeter when exposed to the sun changed its color from yellow to green-blue during 0.75 hour and then returned to the original yellow color after staying 10 hours in the dark. This process was repeated 7 days without significant deterioration of the dosimeter's performances.

Example No. 6

A dosimeter for skin type No. 1 was cast by extrusion casting to obtain thin film with thickness 0.4 mm. The dosimeter comprised polypropylene matrix containing all necessary components. The composition of matrix comprised:

3 g active chemical compound, namely, 1′,3′-Dihydro)-1′,3′.31-tTimethyl,6-nitrospiro[2H-1-benzopyran-2-2′-(2H )-indole];

5 g fixing agent, namely, manganese chloride;

2 g masterbatch of orange color pigment 1. 4299, manufactured by Kafrit Lid., Israel;

1000 g polypropylene.

The dosimeter was exposed to sun radiation with an average intensity of 2 MED/Hour to accumulate UV radiation with efficacy 0.7 MED, The exposure took place during different seasons and during different daytime. For calibration of the dosimeter was used digital dosimeter PMA2100 with detector PMA2101 UVB manufactured by Solar Light Co.

The dosimeter when exposed to the sun changed its color from orange to blue-violet during 20 minutes and then returned to the original orange color after staying 9 hours in the dark.

This process was repeated 30 days without significant deterioration of the dosimeter's performances.

Although certain presently preferred embodiments of the invention have been described herein, it will be apparent to those skilled in the art to which the invention pertains that variations and modifications of the described embodiment may be made without departing from the spirit and scope of the invention. Accordingly, it is intended that the invention be limited only to the extent required by the appended claims and the applicable rules of law.

What is claimed:

1. A dosimeter for sun radiation comprising a matrix having at least one active chemical compound distributed therein, said chemical compound reversibly changes from its original color to a new color when exposed to UV radiation of at least 1 MED dosage, said matrix having a degree of transparency which is sufficient to permit detection of the resulting change of color, said active chemical compound being able to retain its new color at temperatures up to 50° C., and being able to revert to its original color after being kept in darkness for a predetermined time.

2. The dosimeter as defined in claim 1, wherein said active chemical compound changes back to its original color after being kept in darkness for 6-10 hours.

3. The dosimeter as defined in claim 1, wherein said matrix is made of an optically transparent polymeric material selected from the group consisting of:
polycarbonates, polystyrenes, polyolefins; polyacrylates such as polymethylmethacrylates;
polyvinyl derivatives, polyester derivatives, polyvinyl chloride;
celluose derivatives such as cellulose acetate;
polyurethanes, polyethylene terephthalate, silicone resins, triethylene glycol dimethacrylate, epoxy resins, and combinations thereof.

4. The dosimeter as defined in claim 1, further including an absorbing compound selected from the group consisting of:
2,4-bis (2,4-dimethylphenyl)-6-(2-hydroxy-4-n-octyl-oxyphenyl)-1,3,5-triazine,
2-hydroxy-4-(N-octoxy)benzophenone,
2-(2-hydroxy-5-methyl-phenyl)-2H-benzotriazole,
2-(2H-benzotriazol-2-YL)-4,6-ditertpentylphenol,
2,2′-dihydroxy-4-methoxybenzophenone,
2,2′4,4′-tetrahydroxybenzophenone,
2,2′-dihydroxy-4,4′-dimethoxybenzophenone, and mixtures thereof.

5. The dosimeter as defined in claim 1, wherein said matrix is formed as a thin layer having a thickness of 0.25-5 mm, the amount of said active chemical compound within said matrix layer being 0.1-10 weight percent.

6. The dosimeter as defined in claim 3, wherein said matrix is provided with an opaque covering layer capable of preventing the premature exposure of the active chemical compound before the dosimeter is put in use, said covering layer being removable before the dosimeter is put in use.

7. The dosimeter as defined in claim 4, wherein said active chemical compound and said absorbing compound are homogeneously distributed within said matrix.

8. The dosimeter as defined in claim 7, wherein said absorbing compound is distributed within the matrix so as to create therein an effective gradient of concentration of the absorbing compound, said gradient of concentration being directed from one lateral side of the dosimeter to the opposite lateral side thereof.

9. The dosimeter as defined in claim 1, wherein said active chemical compound is distributed within the matrix so as to create therein an effective gradient of concentration of the active compound, said gradient being opposite to the gradient of concentration of said absorbing material.

10. The dosimeter as defined in claim 1, wherein said active chemical compound is homogeneously distributed in the lower portion of the matrix and said absorbing compound is distributed within the upper portion of the matrix.

11. The dosimeter as defined in claim 1, wherein said active chemical compound is selected from the group consisting of chromium hexacarbonyl, viologen derivatives, spiropyrans and spirooxazines derivatives, bis-imidazoles and bis-pyrroles derivatives.

12. The dosimeter as defined in claim 1, wherein said active chemical compound is a spiropyran derivative.

13. The dosimeter as defined in claim 1, wherein said active chemical compound is a spirooxazine derivative.

14. The dosimeter as defined in claim 12, wherein said spiropyran is a spirobenzopyran derivative.

15. The dosimeter as defined in claim 1, wherein said active chemical compound has the formula structure (I).

16. The dosimeter as defined in claim 12, wherein said active chemical compound is a spiropyranopyran derivative.

17. The dosimeter as defined in claim 1, wherein said active chemical compound has the formula structure (II).

18. The dosimeter as defined in claim 12, wherein said active chemical compound is a spiroquinolinopyran derivative.

19. The dosimeter as defined in claim 1, wherein said active chemical compound has the formula structure (III).

20. The dosimeter as defined in claim 1, wherein said active chemical compound has the formula structure (IV).
